(19) United States
(12) Patent Application Publication
(10) Pub. No.: US 2015/0166124 A1
(43) Pub. Date: Jun. 18, 2015

(54) ELASTICALLY AVERAGED ALIGNMENT SYSTEMS AND METHODS THEREOF

(71) Applicant: GM GLOBAL TECHNOLOGY OPERATIONS LLC, Detroit, MI (US)

(72) Inventors: Steven E. Morris, Fair Haven, MI (US); Jennifer P. Lawall, Waterford, MI (US)

(73) Assignee: GM GLOBAL TECHNOLOGY OPERATIONS LLC, Detroit, MI (US)

(21) Appl. No.: 14/108,921

(22) Filed: Dec. 17, 2013

(51) Int. Cl. B62D 27/06; F16B 21/07

(52) U.S. Cl. CPC B62D 27/06; F16B 21/071

(57) ABSTRACT

In one aspect, an elastically averaged alignment system is provided. The system includes a first component including an alignment member, the alignment member including a first tubular member, a second tubular member, and a bridge coupled therebetween. The system also includes a second component including an inner wall defining an alignment aperture. The alignment aperture is configured to receive at least a portion of the alignment member to couple the first component and the second component. The alignment member is an elastically deformable material such that when the alignment member is inserted into the alignment aperture, the alignment member elastically deforms to an elastically averaged final configuration to facilitate aligning the first component relative to the second component in a desired orientation.

### FIELD OF THE INVENTION

The subject invention relates to matable components, and more specifically, to elastically averaged matable components.

### BACKGROUND

Components, in particular vehicular components, which are to be mated together in a manufacturing process are mutually located with respect to each other by alignment features that are oversized holes and/or undersized upstanding bosses. Such alignment features are sized to provide spacing to freely move the components relative to one another to align them without creating an interference therebetween that would hinder the manufacturing process. One such example includes two-way and/or four-way male alignment features, typically upstanding bosses, which are received into corresponding female alignment features, typically apertures in the form of slots or holes. The components are formed with a predetermined clearance between the male alignment features and their respective female alignment features to match anticipated size and positional variation tolerances of the male and female alignment features that result from manufacturing (or fabrication) variances.

As a result, significant positional variation can occur between two mated components having the aforementioned alignment features, which may contribute to the presence of undesirably large variation in their alignment, particularly with regard to gaps and/or spacing therebetween. In the case where misaligned components are also part of another assembly, such misalignments may also affect the function and/or aesthetic appearance of the entire assembly. Regardless of whether such misalignment is limited to two components or an entire assembly, it can negatively affect function and result in a perception of poor quality. Moreover, clearance between misaligned components may lead to relative motion therebetween, which may cause undesirable noise such as squeaking and rattling.

Additionally, some components, particularly components made of compliant materials, may not remain mated to another component due to vehicle movement, passage of time, or other factors. As such, the male alignment features may become disengaged from corresponding female alignment features leading to additional noise and vibration.

### SUMMARY OF THE INVENTION

In one aspect, an elastically averaged alignment system is provided. The system includes a first component including an alignment member, the alignment member including a first tubular member, a second tubular member, and a bridge coupled therebetween. The system also includes a second component including an inner wall defining an alignment aperture. The alignment aperture is configured to receive at least a portion of the alignment member to couple the first component and the second component. The alignment member is an elastically deformable material such that when the alignment member is inserted into the alignment aperture, the alignment member elastically deforms to an elastically averaged final configuration to facilitate aligning the first component relative to the second component in a desired orientation.

In another aspect, a vehicle is provided. The vehicle includes a body and an elastically averaged alignment system integrally arranged within the body. The elastically averaged alignment system includes a first component including an alignment member, the alignment member including a first tubular member, a second tubular member, and a bridge coupled therebetween. The system also includes a second component including an inner wall defining an alignment aperture. The alignment aperture is configured to receive at least a portion of the alignment member to couple the first component and the second component. The alignment member is an elastically deformable material such that when the alignment member is inserted into the alignment aperture, the alignment member elastically deforms to an elastically averaged final configuration to facilitate aligning the first component relative to the second component in a desired orientation.

In yet another aspect, a method of manufacturing an elastically averaged alignment system is provided. The method includes forming a first component including an alignment member, the alignment member including a first tubular member, a second tubular member, and a bridge coupled therebetween. The method further includes forming a second component including an inner wall defining an alignment aperture, the alignment aperture configured to receive at least a portion of the alignment member to couple the first component and the second component. The method further includes forming the alignment member from an elastically deformable material such that when the alignment member is inserted into the alignment aperture, the alignment member elastically deforms to an elastically averaged final configuration to facilitate aligning the first component relative to the second component in a desired orientation

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a plan view of an exemplary elastically averaged alignment system after assembly;

FIG. 2 is a cross-sectional view of the elastically averaged alignment system shown in FIG. 1;

FIG. 3 is a perspective view of an exemplary alignment member, with some parts in phantom, of the elastically averaged alignment system shown in FIGS. 1 and 2;

FIG. 4 is a perspective view of the alignment member shown in FIGS. 1 and 2, and with exemplary retention features;

FIG. 5 is a cross-sectional view of the elastically averaged alignment system shown in FIGS. 1 and 2 with the retention features shown in FIG. 4 and taken along line 5-5;

FIG. 6 is a perspective view of another exemplary alignment member;

FIG. 7 is a perspective view of yet another exemplary alignment member; and

FIG. 8 is a side view of a vehicle that may use any of the elastically averaged alignment systems shown in FIGS. 1-7.

### DETAILED DESCRIPTION

The following description is merely exemplary in nature and is not intended to limit the present disclosure, its application or uses. For example, the embodiments shown are applicable to vehicle body panels, but the alignment system disclosed herein may be used with any suitable components to provide elastic averaging for precision location and alignment of all manner of mating components and component applications, including many industrial, consumer product (e.g., consumer electronics, various appliances and the like), transportation, energy and aerospace applications, and particularly including many other types of vehicular components and applications, such as various interior, exterior and under hood vehicular components and applications. It should be understood that throughout the drawings, corresponding reference numerals indicate like or corresponding parts and features.

As used herein, the term “elastically deformable” refers to components, or portions of components, including component features, comprising materials having a generally elastic deformation characteristic, wherein the material is configured to undergo a resiliently reversible change in its shape, size, or both, in response to application of a force. The force causing the resiliently reversible or elastic deformation of the material may include a tensile, compressive, shear, bending or torsional force, or various combinations of these forces. The elastically deformable materials may exhibit linear elastic deformation, for example that described according to Hooke's law, or non-linear elastic deformation.

Elastic averaging provides elastic deformation of the interface(s) between mated components, wherein the average deformation provides a precise alignment, the manufacturing positional variance being minimized to Xₘᵢₙ, defined by Xₘᵢₙ=X/√N wherein X is the manufacturing positional variance of the locating features of the mated components and N is the number of features inserted. To obtain elastic averaging, an elastically deformable component is configured to have at least one feature and its contact surface(s) that is over-constrained and provides an interference fit with a mating feature of another component and its contact surface(s). The over-constrained condition and interference fit resiliently reversibly (elastically) deforms at least one of the at least one feature or the mating feature, or both features. The resiliently reversible nature of these features of the components allows repeatable insertion and withdrawal of the components that facilitates their assembly and disassembly. Positional variance of the components may result in varying forces being applied over regions of the contact surfaces that are over-constrained and engaged during insertion of the component in an interference condition. It is to be appreciated that a single inserted component may be elastically averaged with respect to a length of the perimeter of the component. The principles of elastic averaging are described in detail in commonly owned, co-pending U.S. patent application Ser. No. 13/187,675, published as U.S. Pub. No. 2013/0019455, the disclosure of which is incorporated by reference herein in its entirety. The embodiments disclosed above provide the ability to convert an existing component that is not compatible with the above-described elastic averaging principles, or that would be further aided with the inclusion of a four-way elastic averaging system as herein disclosed, to an assembly that does facilitate elastic averaging and the benefits associated therewith.

Any suitable elastically deformable material may be used for the mating components and alignment features disclosed herein and discussed further below, particularly those materials that are elastically deformable when formed into the features described herein. This includes various metals, polymers, ceramics, inorganic materials or glasses, or composites of any of the aforementioned materials, or any other combinations thereof suitable for a purpose disclosed herein. Many composite materials are envisioned, including various filled polymers, including glass, ceramic, metal and inorganic material filled polymers, particularly glass, metal, ceramic, inorganic or carbon fiber filled polymers. Any suitable filler morphology may be employed, including all shapes and sizes of particulates or fibers. More particularly any suitable type of fiber may be used, including continuous and discontinuous fibers, woven and unwoven cloths, felts or tows, or a combination thereof. Any suitable metal may be used, including various grades and alloys of steel, cast iron, aluminum, magnesium or titanium, or composites thereof, or any other combinations thereof. Polymers may include both thermoplastic polymers or thermoset polymers, or composites thereof, or any other combinations thereof, including a wide variety of co-polymers and polymer blends. In one embodiment, a preferred plastic material is one having elastic properties so as to deform elastically without fracture, as for example, a material comprising an acrylonitrile butadiene styrene (ABS) polymer, and more particularly a polycarbonate ABS polymer blend (PC/ABS). The material may be in any form and formed or manufactured by any suitable process, including stamped or formed metal, composite or other sheets, forgings, extruded parts, pressed parts, castings, or molded parts and the like, to include the deformable features described herein. The elastically deformable alignment features and associated component may be formed in any suitable manner. For example, the elastically deformable alignment features and the associated component may be integrally formed, or they may be formed entirely separately and subsequently attached together. When integrally formed, they may be formed as a single part from a plastic injection molding machine, for example. When formed separately, they may be formed from different materials to provide a predetermined elastic response characteristic, for example. The material, or materials, may be selected to provide a predetermined elastic response characteristic of any or all of the elastically deformable alignment features, the associated component, or the mating component. The predetermined elastic response characteristic may include, for example, a predetermined elastic modulus.

As used herein, the term vehicle is not limited to just an automobile, truck, van or sport utility vehicle, but includes any self-propelled or towed conveyance suitable for transporting a burden.

Described herein are elastically averaged alignment systems and methods for matable assemblies. The alignment systems include specially shaped alignment members to facilitate a multiple-point interference to limit or prevent movement in predetermined directions. The alignment systems optionally include stand-offs and retention features that facilitate limiting or preventing movement in further predetermined directions. As such, the alignment systems limit or prevent movement which can cause misalignment between two or more matable components, and limit or prevent accidental or premature separation of mated components, thereby maintaining a proper coupling between and desired orientation of two or more components.

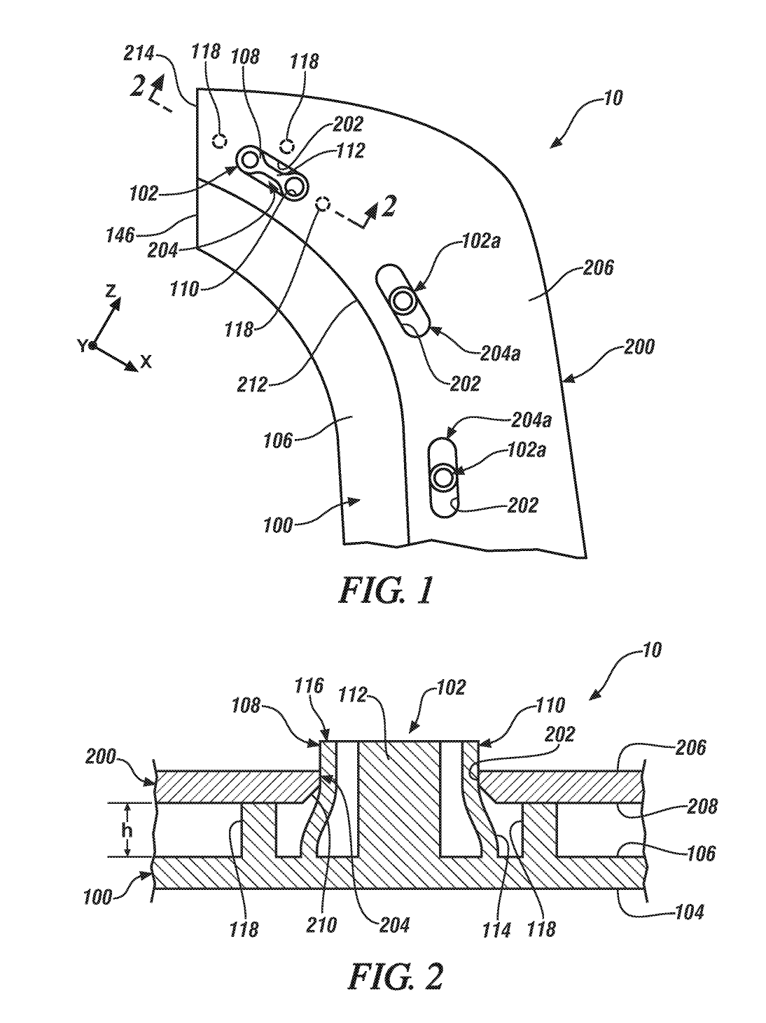

FIGS. 1 and 2 illustrate an exemplary elastically averaged alignment system 10 that generally includes a first component 100 to be mated to a second component 200. First component 100 includes an elastically deformable alignment member 102, and second component 200 includes an inner wall 202 defining an alignment aperture 204. Alignment member 102 and alignment aperture 204 are fixedly disposed on or formed integrally with their respective component 100, 200 for proper alignment and orientation when components 100 and 200 are mated. Although a single alignment member 102 and alignment aperture 204 are illustrated, components 100 and 200 may have any number and combination of corresponding alignment members 102 and alignment apertures 204. Further, as shown, first component 100 may include additional different elastically deformable alignment members 102a (different from members 102), and second component 200 may include additional alignment apertures 204a (different from apertures 204). Elastically deformable alignment members 102, 102a are configured and disposed to interferingly, deformably, and matingly engage alignment apertures 204, 204a, as discussed herein in more detail, to precisely align first component 100 with second component 200 in two or four directions, such as the +/−x-direction and the +/−z-direction of an orthogonal coordinate system, for example, which is herein referred to as two-way and four-way alignment. Moreover, the features of alignment system 10 facilitate reducing or preventing relative yaw, pitch, and roll rotation between components 100 and 200, as described herein in more detail.

In the exemplary embodiment, first component 100 generally includes an outer face 104 and an inner face 106 from which alignment member 102 extends. Alignment member 102 may include a first substantially circular hollow tubular member 108, a second substantially circular hollow tubular member 110, and a bridge 112 coupled therebetween. Alternatively, alignment member 102 may have any cross-sectional shape that enables system 10 to function as described herein. For example, as shown in FIG. 6, first and second tubular members 108 and 110 may have a triangular cross-section. Alignment member 102 further includes a proximal end 114 coupled to inner face 106, and a distal end 116. First component 100 may optionally include one or more standoffs 118 for engaging and supporting second component 200, as described herein in more detail. In the exemplary embodiment, first component 100 is fabricated from an elastically deformable material such as plastic. However, first component 100 may be fabricated from any suitable material that enables system 10 to function as described herein.

Second component 200 generally includes an outer face 206 and an inner face 208. In the exemplary embodiment, alignment aperture 204 is illustrated as a generally elongated slot formed with a chamfer 210. Alternatively, alignment aperture 204 may have any shape that enables system 10 to function as described herein. In the exemplary embodiment, second component 200 is fabricated from a rigid material such as sheet metal. However, second component 200 may be fabricated from any suitable material that enables system 10 to function as described herein.

Moreover, inner wall 202 may be elastically deformable to facilitate added elastic average tuning of system 10. For example, inner wall 202 and/or a surrounding portion of second component 200 may be made from an elastically deformable material and/or have a smaller thickness than the rest of component 200. As such, during insertion of alignment member 102 into alignment aperture 204, inner wall 202 and/or a surrounding portion of component 200 elastically deforms to an elastically averaged final configuration to facilitate aligning first component 100 and second component 200 in a desired orientation. Accordingly, first component tube thickness and second component material thickness may be adjusted to tune the elastic average mating between first component 100 and second component 200.

While not being limited to any particular structure, first component 100 may be a decorative trim component of a vehicle with the customer-visible side being outer face 104, and second component 200 may be a supporting substructure that is part of, or is attached to, the vehicle and on which first component 100 is fixedly mounted in precise alignment.

To provide an arrangement where elastically deformable alignment member 102 is configured and disposed to interferingly, deformably and matingly engage alignment aperture 204, the width, length, and/or diameter of alignment aperture 204 is less than the diameter or cross-section of alignment member 102, which necessarily creates a purposeful interference fit between the elastically deformable alignment member 102 and alignment aperture 204. Further, second component 200 may include chamfer 210 to facilitate insertion of alignment member 102. As such, when inserted into alignment aperture 204, portions of the elastically deformable alignment member 102 elastically deform to an elastically averaged final configuration that aligns alignment member 102 with the alignment aperture 204 in four planar orthogonal directions (the +/−x-direction and the +/−z-direction). Where a length of alignment member 102 is less than the length of elongated slot 204, alignment member 102 is aligned in two planar orthogonal directions (the +/−x-direction or the +/−z-direction) such that alignment member 102 may translate along slot 204 while still reducing or preventing rotational yaw. Further, bridge 112 may bend and/or elastically deform when alignment member 102 is inserted into alignment aperture 204 to further facilitate aligning first and second components 100, 200. For example, the length, height, and/or thickness of bridge 112 may be varied to produce a desired elastically averaged final configuration of alignment member 102.

Standoffs 118 may be spaced relative to alignment aperture 204 such that they provide a support platform at a height “h” above first component inner face 106. Second component inner face 208 rests upon standoff 118 when elastically deformable alignment member 102 is configured and disposed to interferingly, deformably and matingly engage alignment aperture 204. Stated alternatively, standoffs 118 are disposed and configured to provide a final relative position between alignment aperture 204 and elastically deformable alignment element 102 at an elevation “h” above inner face 106. While FIG. 1 depicts three standoffs 118 in the form of posts at a height “h” (FIG. 2) relative to first component inner face 106, it will be appreciated that the scope of the invention is not so limited and also encompasses other numbers and shapes of standoffs 118 suitable for a purpose disclosed herein, and also encompasses a standoff in the form of a continuous ring disposed around alignment member 102. All such alternative standoff arrangements are contemplated and considered within the scope of the invention disclosed herein. Moreover, while FIG. 2 depicts standoffs 118 integrally formed on inner face 106, it will be appreciated that a similar function may be achieved by integrally forming standoffs 118 on second component inner face 208, which is herein contemplated and considered to be within the scope of the invention disclosed herein.

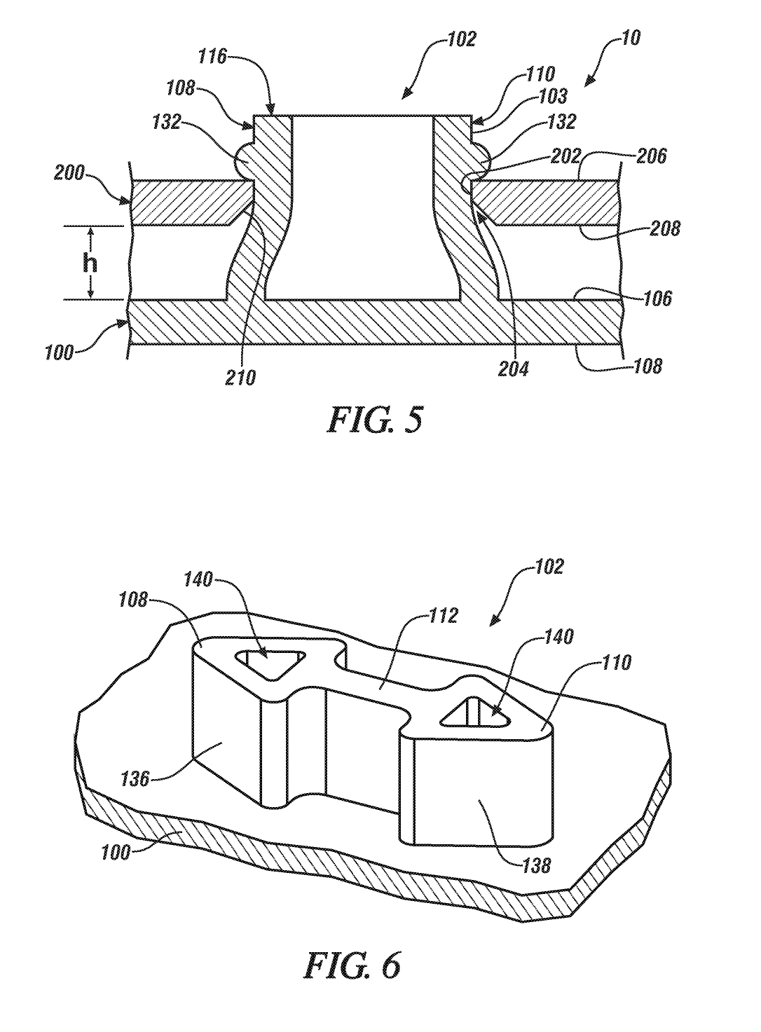

As illustrated in FIGS. 4 and 5, alignment member 102 may include one or more retention features 130 to facilitate retention of alignment member 102 within alignment aperture 204. In the exemplary embodiment, retention feature 130 is a lip or rib 132 extending from an outer wall 103 of alignment member 102 proximate its distal end 116. Rib 132 at least partially circumscribes alignment member 102 and is configured to engage outer face 206 and/or inner wall 202. For example, retention rib 132 interferingly engages outer face 206 to increase the amount of force required to disengage or otherwise back-out alignment member 102 from within alignment aperture 204. FIGS. 4 and 5 also illustrate an additional arrangement where retention feature 130 is an indentation or notch 134 formed in outer wall 103 proximate alignment member distal end 116. Notch 134 at least partially circumscribes alignment member 102 and is configured to receive and engage at least a portion of second component 200. For example, alignment member 102 is inserted into alignment aperture 204 until inner wall 202 is seated within notch 134 to increase the amount of force required to disengage or otherwise back-out alignment member 102 from within alignment aperture 204. Accordingly, retention features 130 facilitate improved retention of alignment member 102 within alignment aperture 204. Further, although illustrated with rib 132 formed on first tubular member 108 and notch 134 formed on second tubular member 110, tubular members 108, 110 and bridge 112 may have any combination, number, and location of retention features 130 that enables system 10 to function as described herein.

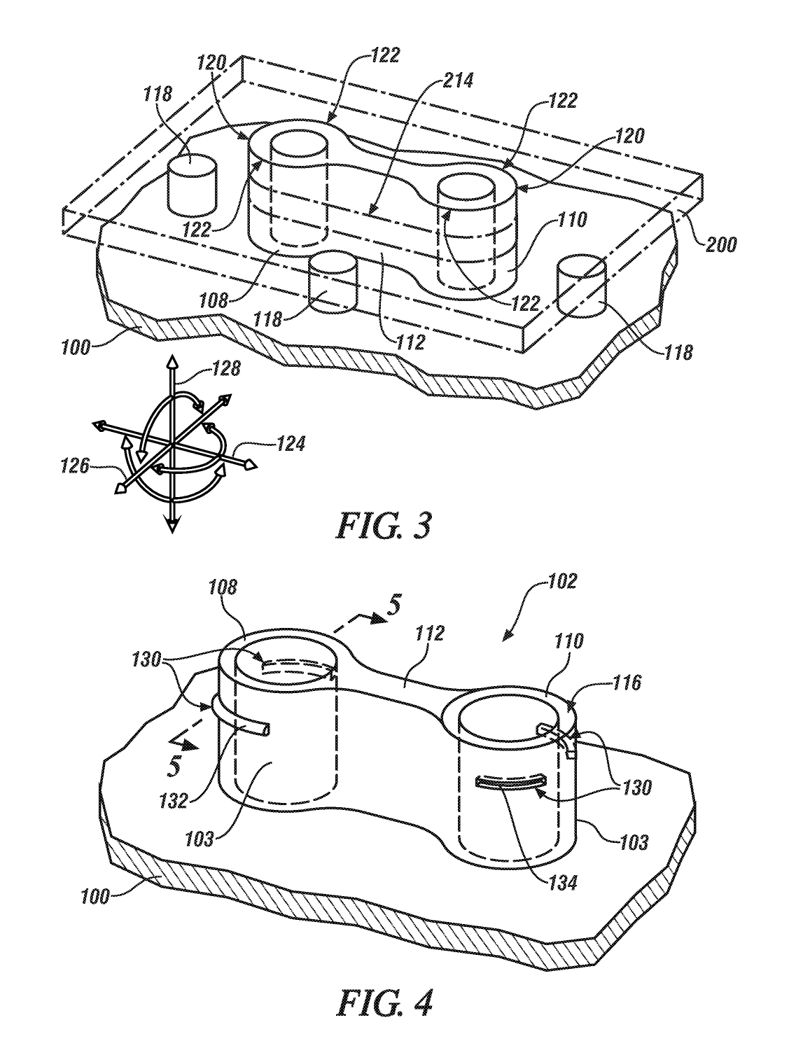

As shown in FIGS. 1-5, alignment member 102 has a generally “dog-bone” shape that facilitates providing six points of interference with inner wall 202. Specifically, the shape of first and second tubular members 108, 110 facilitates an interference fit with inner wall 202 at two end locations 120 and four side locations 122. As such, alignment member 102 reduces variation over components 100, 200 and restricts or prevents movement therebetween in three degrees of freedom; i.e., lateral movement along a roll axis 124, forward/back movement along a pitch axis 126, and rotational yawing about a yaw axis 128 (see FIG. 3). Further, standoffs 118 restrict or prevent movement in another degree of freedom; i.e., rotational roll about roll axis 124. However, depending upon placement, standoffs 118 may also restrict or prevent movement of rotational pitch about pitch axis 126. Finally, with the addition of retention features 130 shown in FIGS. 4 and 5, movement between components 100, 200 may be restricted or prevented in up to three degrees of freedom; i.e., when utilizing notch 134, up/down movement along yaw axis 128, rotational roll about roll axis 124, and rotational pitch about pitch axis 126; when utilizing rib 132, movement may be restricted or prevented for rotational roll about roll axis 124 and rotational pitch about pitch axis 126; and when utilizing rib 132 in combination with standoff 118, movement may be also be restricted or prevented for up/down movement along yaw axis 128.

FIG. 6 illustrates an alternative embodiment of alignment member 102, which includes a first substantially triangular tubular member 136, a second substantially triangular tubular member 138, and bridge 112 coupled therebetween. Each of tubular members 136, 138 includes a substantially triangular aperture 140 extending therethrough. However, aperture 140 may have any shape that enables alignment member 102 to function as described herein. As such, the shape of triangular tubular members 136, 138 facilitates providing six locations of interference with second component 200; i.e., two end locations 120 and four side locations 122.

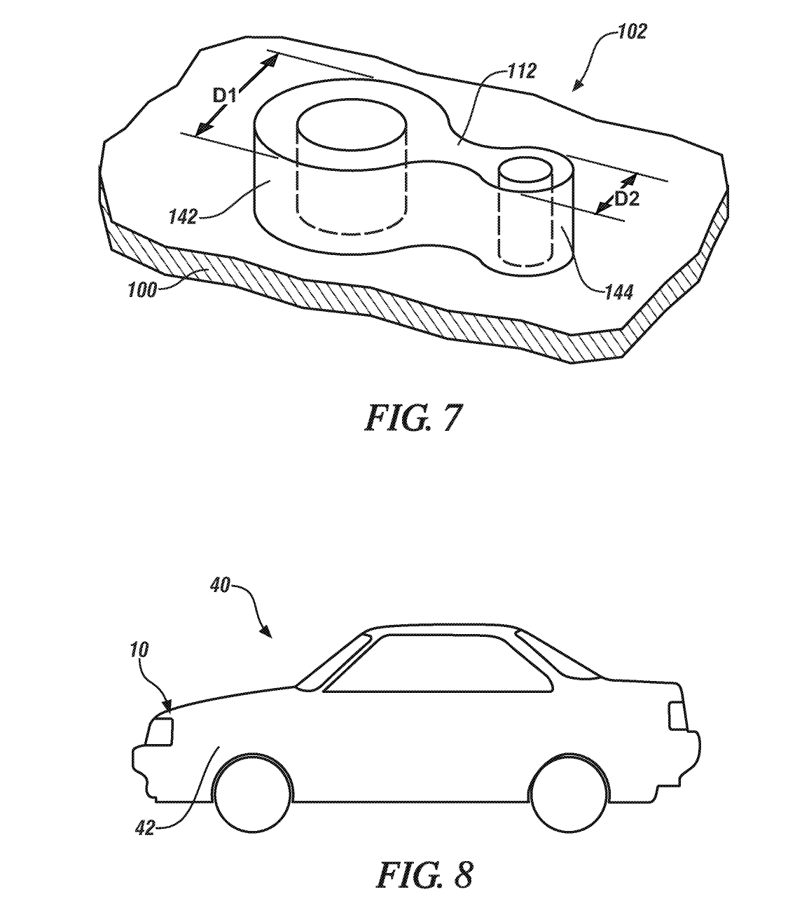

FIG. 7 illustrates another alternative embodiment of alignment member 102, which includes a first substantially circular tubular member 142, a second substantially circular tubular member 144, and bridge 112 coupled therebetween. In the exemplary embodiment, tubular member 142 has a diameter D1 that is larger than a diameter D2 of tubular member 144. Diameters D1 and D2 may be variably designed for different sized alignment apertures 204 and/or specialized connections between first component 100 and second component 200. As such, the shape of tubular members 142, 144 facilitates providing six locations of interference with second component 200; i.e., two end locations 120 four side locations 122. Further, the embodiments shown in FIGS. 6 and 7 may include one or more retention features 130 and/or standoffs 118.

While FIGS. 1-7 depict only a single elastically deformable alignment member 102 in a corresponding aperture 204 to provide four-way alignment of the first component 100 relative to the second component 200, it will be appreciated that the scope of the invention is not so limited and encompasses other quantities and types of elastically deformable alignment elements used in conjunction with the elastically deformable alignment member 102 and corresponding aperture 204. For example, as illustrated in FIG. 1, first component 100 includes additional elastically deformable alignment members 102a, and second component 200 includes additional corresponding alignment apertures 204a. Moreover, as illustrated in FIG. 1, alignment member 102 and corresponding alignment aperture 204 are particularly well-suited for components having limited space as this singular feature can align in multiple axes. In this embodiment, alignment member 102 and alignment aperture 204 are located proximate a curved edge 212 to facilitate close alignment between an end edge 146 of first component 100 and an end edge 214 of second component 200 as well as interfacing side edge 212 with first component 100; whereas the additional two alignment members 102a facilitate aligning interfacing edge 212. However, alignment member 102 and alignment aperture 204 may be respectively located anywhere on components 100 and 200 that enables system 10 to function as described herein.

In view of all of the foregoing, and with reference now to FIG. 8, it will be appreciated that an embodiment of the invention also includes a vehicle 40 having a body 42 with an elastically averaging alignment system 10 as herein disclosed integrally arranged with the body 42. In the embodiment of FIG. 8, the elastically averaging alignment system 10 is depicted forming at least a portion of a front grill of the vehicle 40. However, it is contemplated that an elastically averaging alignment system 10 as herein disclosed may be utilized with other features or components of vehicle 40, such as interior trim, headliners, bezel trim, compartment bins, seat closeouts, control modules, exterior fascia, lighting closeouts, exterior trim and door moldings.

An exemplary method of fabricating elastically averaged alignment system 10 includes forming first component 100 with at least one of alignment member 102. Second component 200 is formed with inner wall 202 and a chamfer 210 defining alignment aperture 204. Alignment member 102 is formed to be elastically deformable such that when alignment member 102 is inserted into alignment aperture 204, alignment member 102 elastically deforms to an elastically averaged final configuration to facilitate aligning first component 100 and second component 200 in a desired orientation.

In the exemplary embodiment, retention rib 132 and/or retention notch 134 may be formed on alignment member 102 to facilitate engagement and interference between alignment member 102 and second component 200. Further, alignment member 102 may be formed with first tubular member 108, 136, 142, second tubular member 110, 138, 144, and bridge 112 coupled therebetween. One or more standoffs 118 may be formed to extend from first and/or second component 100, 200. As such, the shape of alignment member 102, along with standoff 118, facilitates up to six points of interference between alignment member 102 and second component 200, as well as facilitates reducing or preventing up to six degrees of movement.

Systems and methods for elastically averaged mating assemblies are described herein. The systems generally include a first component with an elastically deformable alignment member positioned for insertion into an alignment aperture of a second component. The mating of the first and second components is elastically averaged over corresponding pair(s) of elastically deformable alignment members and alignment apertures to precisely mate the components in a desired orientation. Moreover, the systems include standoffs for distancing between the two components, and retention features for self-retention of the alignment members within the alignment apertures. The shape of the alignment member provides up to six points of interference with the second component and, along with optional standoffs and retention features, prevents up to six degrees of movement (i.e., up/down, left/right, forward/back, yaw, pitch, and roll). Accordingly, the features described herein facilitate tunable elastically averaged mating systems, facilitate reducing or eliminating the need for fasteners to mate the components, and facilitate reduction or prevention of movement and rotation between matable components.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. An elastically averaged alignment system comprising:
a first component comprising an alignment member, said alignment member comprising a first tubular member, a second tubular member, and a bridge coupled therebetween; and
a second component comprising an inner wall defining an alignment aperture, said alignment aperture configured to receive at least a portion of said alignment member to couple said first component and said second component,
wherein said alignment member is an elastically deformable material such that when said alignment member is inserted into said alignment aperture, said alignment member elastically deforms to an elastically averaged final configuration to facilitate aligning said first component relative to said second component in a desired orientation.

2. The system of claim 1, wherein said first and second tubular members each include a substantially circular aperture.

3. The system of claim 1, wherein said first and second tubular members are substantially circular, and the diameter of said first tubular member is larger than the diameter of said second tubular member.

4. The system of claim 1, wherein said first and second tubular members have a substantially triangular cross-section.

5. The system of claim 1, wherein said first component further comprises at least one standoff extending therefrom.

6. The system of claim 1, wherein said alignment member comprises an outer wall having a retention feature configured to engage said inner wall and facilitate preventing said alignment member from removal from said alignment aperture after insertion therein, wherein said retention feature comprises at least one of a rib extending from said outer wall and a notch formed in said outer wall.

7. The system of claim 1, wherein said alignment aperture is an elongated slot.

8. The system of claim 7, wherein said first component further comprises a second alignment member, and said second component further comprises a second inner wall defining a second alignment aperture, said second alignment member having a tubular body with a substantially circular cross-section.

9. A vehicle comprising:
a body; and
an elastically averaged alignment system integrally arranged within said body, said elastically averaged alignment system comprising:
a first component comprising an alignment member, said alignment member comprising a first tubular member, a second tubular member, and a bridge coupled therebetween; and
a second component comprising an inner wall defining an alignment aperture, said alignment aperture configured to receive at least a portion of said alignment member to couple said first component and said second component,
wherein said alignment member is an elastically deformable material such that when said alignment member is inserted into said alignment aperture, said alignment member elastically deforms to an elastically averaged final configuration to facilitate aligning said first component relative to said second component in a desired orientation.

10. The vehicle of claim 9, wherein said body comprises said second component and said first component comprises vehicle interior trim.

11. The vehicle of claim 9, wherein said first and second tubular members each include a substantially circular aperture.

12. The vehicle of claim 9, wherein said first and second tubular members have a substantially triangular cross-section.

13. A method of manufacturing an elastically averaged alignment system, said method comprising:
forming a first component comprising an alignment member, the alignment member comprising a first tubular member, a second tubular member, and a bridge coupled therebetween;
forming a second component comprising an inner wall defining an alignment aperture, the alignment aperture configured to receive at least a portion of the alignment member to couple the first component and the second component; and
forming the alignment member from an elastically deformable material such that when the alignment member is inserted into the alignment aperture, the alignment member elastically deforms to an elastically averaged final configuration to facilitate aligning the first component relative to the second component in a desired orientation.

14. The method of claim 13, further comprising forming the first and second tubular members with a substantially circular aperture.

15. The method of claim 13, further comprising forming the first and second tubular members as substantially circular tubular members, wherein the diameter of the first tubular member is larger than the diameter of the second tubular member.

16. The method of claim 13, further comprising forming each of the first and second tubular members with a triangular-shaped aperture.

17. The method of claim 13, further comprising forming at least one stand-off on the first component.

18. The method of claim 13, further comprising forming a retention feature on an outer wall of the alignment member, wherein the retention feature is at least one of a rib extending from the outer wall and a notch extending into the outer wall.

19. The method of claim 13, further comprising forming the alignment aperture as an elongated slot.

20. The method of claim 13, further comprising forming a second alignment member on the first component, the second alignment member having a substantially circular cross-section, and forming a second alignment aperture on the second component.
